(19) United States
(12) Patent Application Publication
(10) Pub. No.: US 2025/0147230 A1
(43) Pub. Date: May 8, 2025

(54) OPTICAL FIBER AND METHOD FOR MANUFACTURING OPTICAL FIBER

(71) Applicant: FURUKAWA ELECTRIC CO., LTD., Tokyo (JP)

(72) Inventors: Kuniaki ISHIZUKI, Tokyo (JP); Mitsuhiro IWAYA, Tokyo (JP)

(73) Assignee: FURUKAWA ELECTRIC CO., LTD., Tokyo (JP)

(21) Appl. No.: 19/014,700

(22) Filed: Jan. 9, 2025

Related U.S. Application Data
(63) Continuation of application No. PCT/JP2024/001664, filed on Jan. 22, 2024.

(30) Foreign Application Priority Data
Jan. 30, 2023 (JP) 2023-012316

(51) Int. Cl. G02B 6/02; C03C 25/1065

(52) U.S. Cl. CPC G02B 6/02395; C03C 25/1065

(57) ABSTRACT

The present invention intends to suppress curing of a primary layer over time after manufacturing an optical fiber and to effectively suppress microbend loss. The optical fiber according to the present invention including a bare optical fiber, a primary layer formed of a first ultraviolet curing resin covering the bare optical fiber and a secondary layer formed of a second ultraviolet curing resin covering the primary layer. A Young's modulus of the primary layer is larger than or equal to 0.2 MPa and smaller than or equal to 2.1 MPa. The primary layer includes at least one of an alkoxysilane-derived chemical structure or a halosilane-derived chemical structure.

### CROSS-REFERENCE TO RELATED APPLICATIONS

This application is a continuation application of International Application No. PCT/JP2024/001664, filed Jan. 22, 2024, which claims the benefit of Japanese Patent Application No. 2023-012316, filed Jan. 30, 2023, both of which are hereby incorporated by reference herein in their entirety.

### BACKGROUND OF THE INVENTION

### Field of the Invention

The present invention relates to an optical fiber and a method for manufacturing the optical fiber.

### Description of the Related Art

In an optical fiber, a technique in which a primary layer covering a bare optical fiber and a secondary layer covering the primary layer are set to a desired Young's modulus respectively by an ultraviolet curing resin (Japanese Patent Application Laid-Open No. 2005-162522 and International Publication No. 2018/062364) is known. For example, a Young's modulus of the primary layer is set to be small, and the primary layer absorbs an external force applied to the bare optical fiber, thereby suppressing a transmission loss of light due to small deformation of the bare optical fiber (microbend loss). A Young's modulus of the secondary layer is set to be larger than the Young's modulus of the primary layer, and the secondary layer protects the bare optical fiber and the primary layer from external force.

In addition, a technique is known in which a silane coupling agent is added to an ultraviolet curing resin to adhere the primary layer and the bare optical fiber (Japanese Patent Application Laid-Open No. 2003-212609). The silane coupling agent binds to the ultraviolet curing resin of the primary layer and reacts with the hydroxy group on the surface of the bare optical fiber. When the ultraviolet curing resin of the primary layer and the bare optical fiber are bonded to each other through the silane coupling agent, the primary layer and the bare optical fiber are adhered.

### SUMMARY OF THE INVENTION

The ultraviolet curing resin of the primary layer is crosslinked through the silane coupling agent, and curing of the primary layer may proceed. Therefore, depending on the type of the silane coupling agent, the curing of the primary layer proceeds for a long period of time after manufacturing the optical fiber, and microbend loss cannot be effectively avoided.

The present invention has been made in view of the above and intends to suppress curing of a primary layer over time after manufacturing an optical fiber and to effectively suppress microbend loss.

According to one aspect of the present invention, provided is an optical fiber including a bare optical fiber, a primary layer formed of a first ultraviolet curing resin covering the bare optical fiber and a secondary layer formed of a second ultraviolet curing resin covering the primary layer. A Young's modulus of the primary layer is larger than or equal to 0.2 MPa and smaller than or equal to 2.1 MPa. The primary layer includes at least one of an alkoxysilane-derived chemical structure or a halosilane-derived chemical structure.

According to another aspect of the present invention, provided is a method for manufacturing an optical fiber including a step of drawing a bare optical fiber from an optical fiber preform, a step of forming a primary layer by applying a first ultraviolet curing resin around the bare optical fiber and a step of forming a secondary layer by applying a second ultraviolet curing resin around the primary layer. A Young's modulus of the primary layer is larger than or equal to 0.2 MPa and smaller than or equal to 2.1 MPa. The primary layer includes at least one of an alkoxysilane-derived chemical structure or a halosilane-derived chemical structure.

According to the present invention, it is possible to suppress curing of the primary layer over time after manufacturing of an optical fiber, and to effectively suppress microbend loss.

### BRIEF DESCRIPTION OF THE DRAWINGS

FIG. 1 is a cross-sectional view of an optical fiber according to one embodiment.

FIG. 2 is a schematic diagram illustrating a part of a manufacturing apparatus used in a method for manufacturing an optical fiber according to the embodiment.

FIG. 3 is a schematic diagram illustrating a part of a manufacturing apparatus used in a method of manufacturing an optical fiber according to the embodiment.

FIG. 4 is a flowchart of a method for manufacturing an optical fiber according to one embodiment.

FIG. 5 is a graph illustrating a microbend loss with respect to Young's modulus differences of optical fibers.

FIG. 6 is a graph illustrating a change over time in Young's modulus of an ultraviolet curing resin after ultraviolet irradiation.

### DESCRIPTION OF THE EMBODIMENTS

Embodiments according to the present invention will be described below with reference to the drawings. Throughout the drawings, components having the same function are labeled with the same references, and the repetitive description thereof will be omitted.

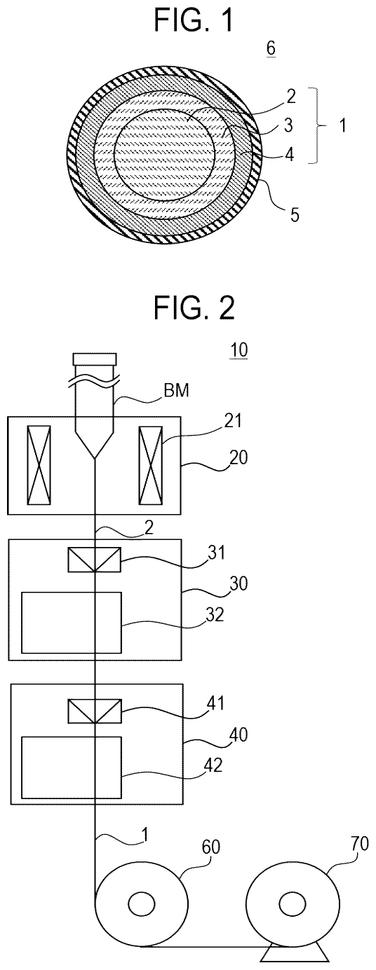

FIG. 1 is a cross-sectional view of an optical fiber according to the present embodiment. FIG. 1 illustrates a colored optical fiber 6 as an example of the optical fiber according to the present embodiment. A coated optical fiber 1 includes a bare optical fiber 2, a primary layer 3 covering the outer periphery of the bare optical fiber 2, a secondary layer 4 covering the outer periphery of the primary layer 3, and a colored layer 5 covering the outer periphery of the secondary layer 4. The colored optical fiber 6 further includes a colored layer 5 covering the outer periphery of the coated optical fiber 1. The bare optical fiber 2 is coated with three coating layers of the primary layer 3, the secondary layer 4, and the colored layer 5.

The bare optical fiber 2 is formed of, for example, quartz-based glass, and transmits light. The primary layer 3 is a soft layer and has a function of buffering an external force applied to the bare optical fiber 2. The Young's modulus of the primary layer 3 may be preferably larger than or equal to 0.2 MPa and smaller than or equal to 2.1 MPa. The secondary layer 4 is a hard layer and has a function of protecting the bare optical fiber 2 and the primary layer 3 from an external force. The Young's modulus of the secondary layer 4 may be preferably larger than or equal to 500 MPa and smaller than or equal to 2000 MPa. The colored layer 5 is colored to identify the colored optical fiber 6. The colored layer 5 may be the secondary layer 4 colored with a coloring agent. The coloring agent may be a mixture including a pigment or a lubricant.

When an external force is applied to the bare optical fiber 2, a transmission loss of light occurs due to minute deformation of the bare optical fiber 2 (microbend loss). By setting the Young's modulus of the primary layer 3 to be small, the function of buffering the external force of the primary layer 3 is improved, and the microbend loss is suppressed.

The diameter of the colored optical fiber 6 may be larger than or equal to 190 μm and smaller than or equal to 250 μm. The diameter of the bare optical fiber 2 may be larger than or equal to 80 μm and smaller than or equal to 150 μm, and preferably larger than or equal to 124 μm and smaller than or equal to 126 μm. The thickness of the primary layer 3 may be larger than or equal to 5 μm and smaller than or equal to 60 μm. The thickness of the secondary layer 4 may be larger than or equal to 5 μm and smaller than or equal to 60 μm. The thickness of the colored layer 5 may be several micrometers. Here, the diameter of the colored optical fiber 6 may be determined by the sum of the diameter of the bare optical fiber 2, the length twice the thickness of the primary layer 3, the length twice the thickness of the secondary layer 4, and the length twice the thickness of the colored layer 5. Therefore, the diameter of the bare optical fiber 2, the thickness of the primary layer 3, the thickness of the secondary layer 4, and the thickness of the colored layer 5 may be selected so that the diameter of the coated optical fiber 1 is larger than or equal to 190 μm and smaller than or equal to 250 μm.

The effective core cross-sectional area Aeff (effective core cross-sectional area) is an index indicating the easiness of microbend loss of the optical fiber. The effective core cross-sectional area Aeff is represented by the following Equation (1). Note that the effective core cross-sectional area Aeff is described in, for example, C-3-76 and C-3-77 of preprints of the Institute of Electronics, Information and Communication Engineers Society Conference, 1999.

$$( Effective core cross sectional area ) = ( π k / 4 ) * {( M F D )}^{2} \qquad ( Equation ( 1 ) )$$

Here, the effective core cross-sectional area Aeff is a value at a wavelength of 1550 nm, MFD is a mode field diameter (μm), and k is a constant. The effective core cross-sectional area Aeff represents an area of a portion through which light having a predetermined intensity passes in a cross-section orthogonal to the axis of the bare optical fiber 2. Generally, the larger the effective core cross-sectional area Aeff of the bare optical fiber 2, the weaker the optical confinement in the cross section of the bare optical fiber 2. That is, when the effective core cross-sectional area Aeff of the bare optical fiber 2 is large, light in the bare optical fiber 2 tends to leak by an external force applied to the bare optical fiber 2. Therefore, when the effective core cross-sectional area Aeff of the bare optical fiber 2 becomes large, microbend loss of the colored optical fiber 6 tends to occur.

On the other hand, by increasing the effective core cross-sectional area of the bare optical fiber 2, the light intensity per unit area in the cross section of the bare optical fiber 2 can be reduced. Thus, the nonlinear optical effect in the bare optical fiber 2 can be suppressed.

The colored optical fiber 6 according to the present embodiment includes a primary layer 3 capable of effectively buffering an external force applied to the colored optical fiber 6. Thus, even when the effective core cross-sectional area of the bare optical fiber 2 is large, the microbend loss of the colored optical fiber 6 can be effectively suppressed.

The effective core cross-sectional area Aeff of the bare optical fiber 2 is preferably larger than or equal to 80 μm², for example, larger than or equal to 130 μm² and smaller than or equal to 150 μm². Thus, the colored optical fiber 6 capable of suppressing the nonlinear optical effect in the bare optical fiber 2 can be obtained.

The primary layer 3, the secondary layer 4, and the colored layer 5 are formed by curing an ultraviolet curing resin by ultraviolet irradiation. The ultraviolet curing resin of the primary layer 3 (first ultraviolet curing resin) in the present embodiment includes a silane coupling agent and a photoacid generator as additives. The primary layer 3 includes at least one of an alkoxysilane-derived chemical structure or a halosilane-derived chemical structure. Further, the primary layer 3 is acidic. Hereinafter, the ultraviolet curing resin, the silane coupling agent, and the photoacid generator will be described in detail.

### [Ultraviolet Curing Resin]

The ultraviolet curing resin is a resin that is polymerized and cured by ultraviolet light energy. The ultraviolet curing resin is not particularly limited as long as it can be polymerized by irradiation with ultraviolet light. The ultraviolet curing resin may be a resin that can be polymerized by photoradical polymerization or the like, for example.

The ultraviolet curing resin may be an ultraviolet curing resin having a polymerizable unsaturated group such as an ethylenic unsaturated group polymerized and cured by ultraviolet light such as urethane (meth)acrylates such as polyether-based urethane (meth)acrylates and polyester-based urethane (meth)acrylates, epoxy (meth)acrylates, polyester (meth)acrylates, or the like, for example, and it is preferable that the resin have at least two polymerizable unsaturated groups.

A polymerizable unsaturated group in the ultraviolet curing resin may be, for example, a group having an unsaturated double bond such as a vinyl group, an allyl group, an acryloyl group, a methacryloyl group, or the like, a group having an unsaturated triple bond such as a propargyl group, or the like. The acryloyl group and the methacryloyl group are preferable out of the groups described above in terms of polymerizability.

The ultraviolet curing resin may be a monomer, an oligomer, or a polymer that initiates polymerization by ultraviolet irradiation to be cured and preferably is an oligomer. Note that the oligomer is a polymer having a degree of polymerization of 2 to 100. Further, in the present specification, the term “(meth)acrylates” means one or both of acrylates and methacrylates. The ultraviolet curing resin includes an arbitrary photopolymerization initiator having sensitivity in the ultraviolet region.

Polyether-based urethane (meth)acrylate is a compound having a polyether segment, (meth)acrylate, and a urethane bond as with a product in a reaction of polyol having a polyether framework with an organic polyisocyanate compound and hydroxyalkyl (meth)acrylate. Further, polyester-based urethane (meth)acrylate is a compound having a polyester segment, (meth)acrylate, and a urethane bond as with a product in a reaction of polyol having a polyester framework with an organic polyisocyanate compound and hydroxyalkyl (meth)acrylate.

Further, the ultraviolet curing resin may include, for example, a diluent monomer, a photosensitizer, an ultraviolet absorber, an antioxidant, a chain transfer agent, and various additives in addition to an oligomer and a photopolymerization initiator. As diluent a monomer, monofunctional (meth)acrylate, or polyfunctional (meth)acrylate is used. The diluent monomer here means a monomer used for diluting an ultraviolet curing resin.

### [Silane Coupling Agent]

The silane coupling agent is used to adhere the primary layer 3 and the surface of the bare optical fiber 2. The silane coupling agent is a compound including Si (silicon, silane). The silane coupling agent includes an organic reaction site that reacts with an organic compound and an inorganic reaction site that reacts with an inorganic compound. Examples of the organic reaction site include an amino group, an epoxy group, a (meth)acryloyloxy group, a vinyl group, and a mercapto group. Examples of the inorganic reaction site include a methoxy group, an ethoxy group, and an acetoxy group. Specific examples of the silane coupling agent include, but are not limited to, tetramethylsilicate, tetraethylsilicate, vinyltrichlorosilane, vinyltrimethoxysilane, vinyltriethoxysilane, 2-(3,4-epoxycyclohexyl)ethyltrimethoxysilane, 3-glycidoxypropylmethyldimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloyloxypropyltrimethoxysilane, N-2-(aminoethyl)-3-aminopropylmethyldimethoxysilane, N-2-(aminoethyl)-3-aminopropyltrimethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, tris-(trimethoxysilylpropyl)isocyanurate, 3-ureidopropyltrialkoxysilane, 3-mercaptopropylmethyldimethoxysilane, 3-mercaptopropyltrimethoxysilane, 3-mercaptopropyltriethoxysilane, and 3-isocyanatopropyltriethoxysilane.

The organic reaction site of the silane coupling agent is bonded to the ultraviolet curing resin of the primary layer 3. The silane coupling agent bonded to the ultraviolet curing resin of the primary layer 3 reacts with the surface of the bare optical fiber 2 by hydrolysis at the inorganic reaction site and subsequent dehydration condensation with the hydroxy group on the surface of the bare optical fiber 2. The ultraviolet curing resin of the primary layer 3 and the bare optical fiber 2 are bonded to each other via the silane coupling agent, whereby the primary layer 3 and the bare optical fiber 2 are adhered.

The inorganic reaction site of the silane coupling agent may react with the inorganic reaction site of another silane coupling agent. The reaction between the silane coupling agents may be, for example, dehydration condensation. Thus, the ultraviolet curing resin of the primary layer 3 is crosslinked through the silane coupling agent. In other words, the primary layer 3 includes an alkoxysilane-derived chemical structure. When the silane coupling agent added to the ultraviolet curing resin of the primary layer 3 includes a halosilane-derived chemical structure, the primary layer 3 includes a halosilane-derived chemical structure.

### [Photoacid Generator]

The Young's modulus of the primary layer 3 increases with time by crosslinking the ultraviolet curing resin of the primary layer 3 through the silane coupling agent. In the optical fiber of the present embodiment, the reaction rate between the silane coupling agents is increased, and the increase in Young's modulus of the primary layer 3 with time after manufacturing the colored optical fiber 6 is suppressed. For example, by making the primary layer 3 neutral, more preferably acidic, hydrolysis of the silane coupling agent is promoted, and the reaction rate between the silane coupling agents may be increased. An example of a method for making the primary layer 3 acidic is to add a photoacid generator to the ultraviolet curing resin of the primary layer 3. In addition, by increasing the curing temperature of the primary layer 3, crosslinking between the silane coupling agents is promoted, and the reaction rate between the silane coupling agents may be increased. The curing temperature of the primary layer 3 may be increased by the heat during drawing of the bare optical fiber 2 or by the curing heat of the primary layer 3.

The photoacid generator decomposes by absorption of ultraviolet light and generates an acid by extracting hydrogen from the solvent or the photoacid generator itself. The light absorbed by the photoacid generator varies depending on the type of the photoacid generator, and may be, for example, ultraviolet light in a wavelength region of larger than or equal to 10 nm and smaller than or equal to 405 nm.

The photoacid generator is not particularly limited as long as it generates an acid upon irradiation with ultraviolet light. The photoacid generator may be roughly classified into an onium salt photoacid generator and a nonionic photoacid generator. In the present embodiment, at least one of an onium salt photoacid generator and a nonionic photoacid generator is used, but other types of photoacid generators may be used.

Examples of the onium salt-based photoacid generator include, but are not particularly limited to, an organic sulfonium salt compound, an organic iodonium salt compound, an organic oxonium salt compound, an organic ammonium salt compound, and an organic phosphonium salt compound, which include a hexafluoroantimonate anion, a tetrafluoroborate anion, a hexafluorophosphate anion, a hexachloroantimonate anion, and a trifluoromethanesulfonate ion or those having a counter anion such as a fluorosulfonic acid ion can be given. These may be used alone or as a mixture of two or more kinds thereof.

Examples of commercially available onium salt photoacid generators include IRGACURE (registered trademark, hereinafter omitted) 250, IRGACURE 270, IRGACURE PAG 290, GSID26-1 (so far, manufactured by BASF, product name), WPI-113, WPI-116, WPI-169, WPI-170, WPI-124, WPAG-336, WPAG-367, WPAG-370, WPAG-469, WPAG-638 (so far, manufactured by Wako Pure Chemical Industries, Ltd., product name), B2380, B2381, C1390, D2238, D2248, D2253, N0591, N1066, T1608, T1609, T2041, T2042 (so far, manufactured by Tokyo Chemical Industry Co. Ltd., product name), CPI-100, CPI-100P, CPI-101A, CPI-200K, CPI-210S, IK-1, IK-2 (so far, manufactured by San-Apro Ltd., product name), SP-056, SP-066, SP-130, SP-140, SP-150, SP-170, SP-171, SP-172 (so far, manufactured by ADEKA Corporation, product name), CD-1010, CD-1011, CD-1012 (so far, manufactured by Sartomar, product name), PI2074 (manufactured by Rhodia Japan Ltd., product name), or the like.

The nonionic photoacid generator is not particularly limited, and examples thereof include a phenacylsulfone photoacid generator, an o-nitrobenzyl ester photoacid generator, an iminosulfonate photoacid generator, and sulfonic acid ester photoacid generator of N-hydroxyimide. These may be used alone or as a mixture of two or more kinds thereof. Specific examples of the nonionic photoacid generator include sulfonyldiazomethane, oximesulfonate, imidesulfonate, 2-nitrobenzylsulfonate, disulfone, pyrogallolsulfonate, p-nitrobenzyl-9,10-dimethoxyanthracene-2-sulfonate, N-sulfonyl-phenylsulfonamide, trifluoromethanesulfonic acid-1,8-naphthalimide, acid-1,8-naphthalimide, nonafluorobutanesulfonic acid-1,8-naphthalimide, perfluorooctanesulfonic acid-1,8-naphthalimide, pentafluorobenzenesulfonic nonafluorobutanesulfonic acid-1,3,6-trioxo-3,6-dihydro-1H-11-thia-azacyclopentaanthracen-2-yl ester, nonafluorobutanesulfonic acid-8-isopropyl-1,3,6-trioxo-3,6-dihydro-1H-11-thia-2-azacyclopentaanthracen-2-yl ester, 1,2-naphthoquinone-2-diazido-5-sulfonic acid chloride, 1,2-naphthoquinone-2-diazido-4-sulfonic acid chloride, 1,2-benzoquinone-2-diazido-4-sulfonic acid chloride, sodium 1,2-naphthoquinone-2-diazido-5-sulfonic acid, sodium 1,2-naphthoquinone-2-diazido-4-sulfonic acid, sodium 1,2-benzoquinone-2-diazido-4-sulfonic acid, potassium 1,2-naphthoquinone-2-diazido-5-sulfonate, potassium 1,2-naphthoquinone-2-diazido-4-sulfonate, potassium 1,2-benzoquinone-2-diazido-4-sulfonate, methyl 1,2-naphthoquinone-2-diazido-5-sulfonate, and methyl 1,2-benzoquinone-2-diazido-4-sulfonate.

Commercially available products of the nonionic photoacid generator include, for example, WPAG-145, WPAG-149, WPAG-170, WPAG-199 (so far, manufactured by Wako Pure Chemical Industries Ltd., product name), D2963, F0362, M1209, M1245 (so far, manufactured by Tokyo Chemical Industry Co. Ltd, product name), SP-082, SP-103, SP-601, SP-606 (so far, manufactured by ADEKA Corporation, product name), SIN-11 (manufactured by SANBO CHEMICAL Industries Co., Ltd., product name), and NT-1TF (manufactured by San-Apro Ltd., product name), or the like.

The acid generated from the photoacid generator promotes hydrolysis and dehydration condensation of the silane coupling agent, thereby improving the adhesion between the bare optical fiber 2 and the primary layer 3. It is preferable that at least a part of a wavelength region of light for curing the ultraviolet curing resin of the primary layer 3 overlaps with a wavelength region of light for generating an acid in the photoacid generator. Accordingly, the curing of the ultraviolet curing resin of the primary layer 3 and the generation of acid by the photoacid generator can be simultaneously performed by light from one type of light source.

In addition, the reaction between the silane coupling agents is promoted by the acid generated from the photoacid generator. As a result, the period in which the Young's modulus of the primary layer 3 increases can be shortened, and curing of the primary layer 3 over time after manufacturing the colored optical fiber 6 can be suppressed.

### [Manufacturing Apparatus]

Next, a manufacturing apparatus used in a method for manufacturing an optical fiber according to the present embodiment will be described. FIG. 2 is a schematic diagram illustrating a part of a manufacturing apparatus 10 used in a method for manufacturing an optical fiber according to the present embodiment. The manufacturing apparatus 10 includes a heating apparatus 20, a primary layer covering apparatus 30, a secondary layer covering apparatus 40, a guide roller 60 and a winding apparatus 70. In FIG. 2, the manufacturing apparatus 10 is an apparatus for manufacturing a coated optical fiber 1 from an optical fiber preform BM.

The optical fiber preform BM is made of quartz glass, for example, and is manufactured by a known method such as a VAD method, an OVD method, or an MCVD method. The heating apparatus 20 includes a heater 21. The heater 21 may be any heat source such as a tape heater, a ribbon heater, a rubber heater, an oven heater, a ceramic heater, a halogen heater, or the like. The end of the optical fiber preform BM is heated and melted by using the heater 21 arranged around the optical fiber preform BM, and a bare optical fiber 2 is drawn by drawing.

Under the heating apparatus 20, a primary layer covering apparatus 30 is provided. The primary layer covering apparatus 30 includes a resin application apparatus 31 and an ultraviolet irradiation apparatus 32. The resin application apparatus 31 holds an ultraviolet curing resin of the primary layer 3. The ultraviolet curing resin of the primary layer 3 may include the above-described silane coupling agent and photoacid generator as additives. The ultraviolet curing resin of the primary layer 3 is applied to the bare optical fiber 2 drawn from the optical fiber preform BM by the resin application apparatus 31.

The ultraviolet irradiation apparatus 32 is provided under the resin application apparatus 31. The ultraviolet irradiation apparatus 32 includes any ultraviolet light source such as a metal halide lamp, a mercury lamp, or a UV-LED. The first ultraviolet curing resin is applied to the bare optical fiber 2 by the resin application apparatus 31 and the bare optical fiber 2 enters the ultraviolet irradiation apparatus 32, and the ultraviolet curing resin of the primary layer 3 is irradiated with ultraviolet light. As a result, the ultraviolet curing resin of the primary layer 3 is cured to form the primary layer 3.

Under the primary layer covering apparatus 30, the secondary layer covering apparatus 40 is provided. The secondary layer covering apparatus 40 includes a resin application apparatus 41 and an ultraviolet irradiation apparatus 42. The resin application apparatus 41 holds an ultraviolet curing resin of the secondary layer 4 (second ultraviolet curing resin). The ultraviolet curing resin of the secondary layer 4 is applied to the primary layer 3 by the resin application apparatus 41.

The ultraviolet irradiation apparatus 42 is provided under the resin application apparatus 41. The ultraviolet irradiation apparatus 42 may have a configuration similar to that of the ultraviolet irradiation apparatus 32. The bare optical fiber 2 in which the primary layer 3 is covered with the ultraviolet curing resin of the secondary layer 4 enters the ultraviolet irradiation apparatus 42, and the ultraviolet curing resin of the secondary layer 4 is irradiated with ultraviolet light. As a result, the ultraviolet curing resin of the secondary layer 4 is cured to form the secondary layer 4. The bare optical fiber 2 is covered with the primary layer 3 and the secondary layer 4 and a coated optical fiber 1 is formed.

The resin application apparatus 31 may be configured to hold the ultraviolet curing resin of the primary layer 3 and the ultraviolet curing resin of the secondary layer 4 separately. In this case, the resin application apparatus 31 applies the ultraviolet curing resin of the primary layer 3 to the bare optical fiber 2, and subsequently applies the ultraviolet curing resin of the secondary layer 4 to the ultraviolet curing resin of the primary layer 3. Further, the ultraviolet irradiation apparatus 32 irradiates the ultraviolet curing resin of the primary layer 3 and the ultraviolet curing resin of the secondary layer 4 applied to the bare optical fiber 2 with ultraviolet light. As a result, the primary layer 3 and the secondary layer 4 are formed. In this case, the manufacturing apparatus 10 does not necessarily need to include the secondary layer covering apparatus 40.

The guide roller 60 and the winding apparatus 70 are provided under the secondary layer covering apparatus 40. The manufactured coated optical fiber 1 is guided by the guide roller 60 and wound around the winding apparatus 70.

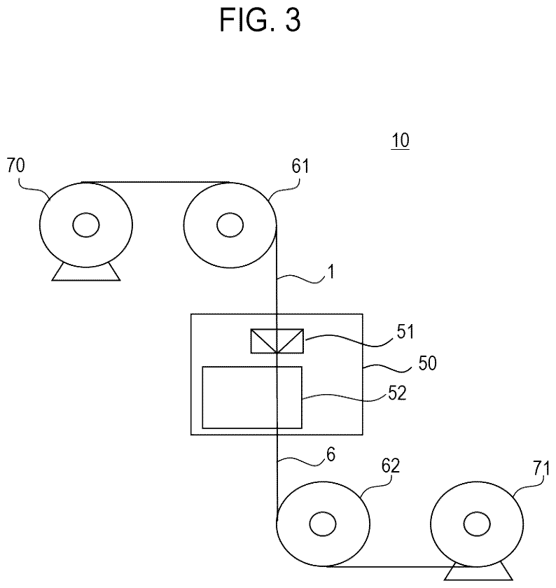

FIG. 3 is a schematic diagram illustrating a part of a manufacturing apparatus 10 used in a method for manufacturing an optical fiber according to the present embodiment. The manufacturing apparatus 10 includes a colored layer covering apparatus 50, guide rollers 61, 62 and winding apparatus 70, 71. In FIG. 3, the manufacturing apparatus 10 is an apparatus for manufacturing a colored optical fiber 6 from a coated optical fiber 1.

The coated optical fiber 1 wound by the winding apparatus 70 is guided by the guide roller 61 and conveyed to the colored layer covering apparatus 50.

The colored layer covering apparatus 50 includes a resin application apparatus 51 and an ultraviolet irradiation apparatus 52. The resin application apparatus 51 holds an ultraviolet curing resin of the colored layer 5. The coated optical fiber 1 is covered with the ultraviolet curing resin of the colored layer 5 by the resin application apparatus 51.

The ultraviolet irradiation apparatus 52 is provided under the resin application apparatus 51. The ultraviolet irradiation apparatus 52 may be configured similarly to the ultraviolet irradiation apparatus 32 and 42. The coated optical fiber 1 covered with the ultraviolet curing resin of the colored layer 5 enters the ultraviolet irradiation apparatus 52 and the ultraviolet curing resin of the colored layer 5 is irradiated with ultraviolet light. As a result, the ultraviolet curing resin of the colored layer 5 is cured to form the colored layer 5. The colored layer 5 is covered with the coated optical fiber 1 to form a colored optical fiber 6.

The guide roller 62 and the winding apparatus 71 are provided under the colored layer covering apparatus 50. The manufactured colored optical fiber 6 is guided by the guide roller 61 and wound by the winding apparatus 71.

### [Manufacturing Method]

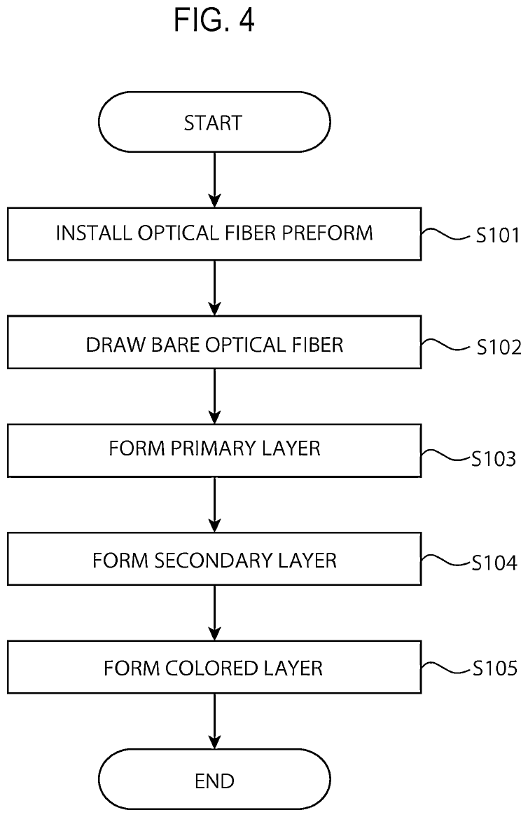

Next, a method for manufacturing the optical fiber according to the present embodiment will be described. FIG. 4 is a flowchart of a method for manufacturing the colored optical fiber 6 according to the present embodiment. First, the optical fiber preform BM is installed in the manufacturing apparatus 10 (step S101).

Next, the heater 21 provided in the heating apparatus 20 heats the optical fiber preform BM and starts drawing the bare optical fiber 2 (step S102).

The primary layer covering apparatus 30 forms the primary layer 3 by applying an ultraviolet curing resin of the primary layer 3 around the drawn bare optical fiber 2, and irradiating the ultraviolet curing resin of the primary layer 3 with ultraviolet light (step S103). The ultraviolet curing resin of the primary layer 3 may include the above-described silane coupling agent and photoacid generator as additives.

Next, the secondary layer covering apparatus 40 forms the secondary layer 4 by applying an ultraviolet curing resin of the secondary layer 4 around the primary layer 3, and irradiating the ultraviolet curing resin of the secondary layer 4 with ultraviolet light (step S104). Thus, a coated optical fiber 1 is obtained. The coated optical fiber 1 after manufacturing is wound by the winding apparatus 70.

Next, the colored layer covering apparatus 50 forms the colored layer 5 by applying an ultraviolet curing resin of the colored layer 5 around the coated optical fiber 1, and irradiating the ultraviolet curing resin of the colored layer 5 with ultraviolet light (step S105). Thus, a colored optical fiber 6 is obtained. The manufactured colored optical fiber 6 is wound by the winding apparatus 71.

In the step of forming the primary layer 3 (step S103), it is not always necessary to irradiate ultraviolet light. In this case, the primary layer 3 can be cured by irradiation with ultraviolet light in the step of forming the secondary layer 4 (step S104).

In the manufacturing process of the colored optical fiber 6, the primary layer 3 is cured by irradiating the ultraviolet curing resin of the primary layer 3 with ultraviolet light in the step of forming the primary layer 3 (step S103). However, even after the step of forming the primary layer 3, the ultraviolet curing resin of the primary layer 3 is crosslinked through the silane coupling agent, and the curing of the primary layer 3 may proceed for a long period of time. When the curing of the primary layer 3 proceeds too long, the Young's modulus of the primary layer 3 becomes high, and it may be difficult for the primary layer 3 to sufficiently buffer the external force applied to the bare optical fiber 2. This can result in microbend loss. In the present embodiment, by promoting the reaction between the silane coupling agents, the period in which the Young's modulus of the primary layer 3 increases is shortened, and the microbend loss is effectively avoided.

### Effect

As described above, according to the present embodiment, the curing of the primary layer 3 over time after manufacturing the optical fiber can be suppressed, and the microbend loss may be effectively suppressed. Hereinafter, the effect of the present embodiment will be described in detail in comparison with the related art.

As a technique for promoting adhesion between the primary layer 3 and the bare optical fiber 2, it is conceivable to increase reactivity of the silane coupling agent as described in Japanese Patent Application Laid-Open 2003-212609, Japanese Patent Application Laid-Open 2003-95706, Japanese Patent Application Laid-Open 2003-531799, and Japanese Patent Application Laid-Open 2005-55779. Among them, Japanese Patent Application Laid-Open No. 2003-212609 describes adding water to an ultraviolet curing resin in order to accelerate hydrolysis of a silane coupling agent.

In the case where the reactivity of the silane coupling agent is high, there is a possibility that the silane coupling agent in the ultraviolet curing resin reacts before ultraviolet irradiation. For this reason, handling of the ultraviolet curing resin such as storage of the ultraviolet curing resin may be difficult. The silane coupling agent added to the ultraviolet curing resin preferably has high stability before ultraviolet irradiation. For example, a silane coupling agent having a mercapto group has high stability in a state of being added to an ultraviolet curing resin. This may have manufacturing advantages such as, for example, making it easier to form a uniform primary layer 3. However, the present inventors find it clear for the first time that, when the primary layer 3 is formed from such a silane coupling agent having high stability, the ultraviolet curing resin of the primary layer 3 is crosslinked through the silane coupling agent for a long period of time, and the Young's modulus of the primary layer 3 continues to increase for a long period of time of several ten days or more after manufacturing the optical fiber. In particular, in the primary layer 3 having a small Young's modulus, a slight increase in Young's modulus may have a large influence on the properties of the optical fiber such as microbend loss. For this reason, even when it is determined that the inspection in the manufacturing process of the optical fiber such as the microbend loss is passed, the Young's modulus of the primary layer 3 increases over a long period of time, and the microbend loss of the optical fiber after shipment cannot be effectively suppressed in some cases.

As a result of extensive studies, the present inventors have found that microbend loss can be effectively suppressed while preventing the primary layer 3 from being cured for a long period of time by the silane coupling agent having high stability by accelerating the reaction between the silane coupling agents. The reaction between the silane coupling agents is promoted by making the primary layer 3 acidic. As a result, the crosslinking of the ultraviolet curing resin of the primary layer 3 through the silane coupling agent is completed in a short period of time, and the increase in Young's modulus of the primary layer 3 is stopped in a short period of time. Therefore, according to the present embodiment, it is possible to suppress curing of the primary layer 3 over time after manufacturing the optical fiber, and to effectively suppress microbend loss.

### EXAMPLES

Hereinafter, measurement results and an evaluation of an ultraviolet curing resin of a primary layer in an optical fiber according to an embodiment of the present invention will be described.

TABLE 1

| | Silane coupling | Photoacid | | Young's modulus | Young's modulus | Increase amount of | |
|---|---|---|---|---|---|---|---|
| | agent | generator | pH | (after 1 day) | (after 30 days) | Young's modulus | Evaluation |
| | — | wt % | — | MPa | MPa | MPa | — |
| Example 1 | MPTMS | 0.25 | 6.6 | 1.87 | 1.96 | 0.09 | OK |
| Example 2 | MPTMS | 0.75 | 6.2 | 1.88 | 1.91 | 0.03 | OK |
| Example 3 | MPTMS | 1.25 | 5.8 | 1.83 | 1.86 | 0.03 | OK |
| Example 4 | MPTMS | 0.25 | 4.8 | 1.42 | 1.44 | 0.02 | OK |
| Example 5 | MPTMS | 0.25 | 4.7 | 0.70 | 0.71 | 0.01 | OK |
| Example 6 | MPTMS | 0.25 | 4.5 | 0.32 | 0.35 | 0.03 | OK |
| Example 7 | MPTMS | 0.25 | 4.7 | 0.20 | 0.22 | 0.02 | OK |
| Example 8 | MPTES | 0.25 | 6.5 | 1.92 | 1.96 | 0.04 | OK |
| Example 9 | MPTES | 0.75 | 6.3 | 2.01 | 2.02 | 0.01 | OK |
| Example 10 | MPTES | 1.25 | 6.1 | 1.84 | 1.89 | 0.05 | OK |
| Comparative | MPTMS | 0.00 | 6.8 | 1.69 | 2.10 | 0.41 | NG |
| Example 1 | | | | | | | |
| Comparative | MPTES | 0.00 | 6.8 | 1.67 | 1.91 | 0.24 | NG |
| Example 2 | | | | | | | |

In Examples and Comparative Examples, the Young's modulus of a cured resin obtained by curing an ultraviolet curing resin of a primary layer formed into a sheet having a thickness of about 100 μm by irradiating the ultraviolet curing resin with ultraviolet rays was measured. For irradiation with ultraviolet light, a mercury lamp, a UV-LED, or the like that emits UV light was used. As main irradiation conditions, “illuminance 1000 mW/cm², irradiation amount 1000 mJ/cm²”, “illuminance 1000 mW/cm², irradiation amount 500 mJ/cm²”, “illuminance 500 mW/cm², irradiation 1000 mJ/cm²”, “illuminance 500 mW/cm², irradiation amount 500 mJ/cm²”, or the like was used. The illuminance and the irradiation amount may be other conditions. In the illuminance measurement, for example, UV-351 manufactured by ORC MANUFACTURING CO., LTD. in the case of a mercury lamp and UVRT2/UD-T3040T2 manufactured by Topcon Technohouse Corporation in the case of a UV-LED were used. The Young's modulus was calculated by stretching the sample and measuring the force at the time of 2.5% stretching in an atmosphere at a temperature of 25±5° C. and a relative humidity of 50±10% using a Tensilon universal tensile tester at a width of 6 mm, a marking interval of 25 mm, and a tensile speed of 1 mm/min.

Table 1 illustrates a silane coupling agent and a photoacid generator added to the ultraviolet curing resin of the primary layer, the pH of the cured resin, the Young's modulus (MPa) of the cured resin at 1 day after the ultraviolet ray irradiation (Young's modulus (after 1 day)), the Young's modulus (MPa) of the cured resin at 30 days after the ultraviolet ray irradiation (Young's modulus (after 30 days)), the Young's modulus increase amount (MPa) of the cured resin during the period from 1 day after the ultraviolet light irradiation to 30 days after the ultraviolet light irradiation, and an evaluation regarding the Young's modulus increase amount.

“Young's modulus increase amount” in Table 1 is the Young's modulus increase amount of the primary layer before and after 29 days of storage in an atmosphere having a temperature of 25±5° C. and a relative humidity of 50±10%.

“Evaluation” in Table 1 indicates whether or not Young's modulus increase amount of the cured resin in the period from 1 day to 30 days after ultraviolet irradiation satisfies the standard (smaller than or equal to 0.09 MPa). When the Young's modulus increase amount satisfies the standard, the evaluation is judged to be good (OK), and when the Young's modulus increase amount does not satisfy the standard, the evaluation is judged to be poor (NG).

In the Examples and Comparative Examples, the silane coupling agents are 3-mercaptopropyltrimethoxysilane (MPTMS) and 3-mercaptopropyltriethoxysilane (MPTES). MPTMS and MPTES are alkoxysilanes including mercapto groups. In addition to MPTMS and MPTES, a compound having a mercapto group and at least one of an alkoxysilyl group or a halosilyl group may be used in Examples and Comparative Examples.

In the Examples and Comparative Examples, the photoacid generator is CPI (registered trademark)-200K of San-Apro Ltd., but any photoacid generator that generates acid upon ultraviolet irradiation can be used.

In Examples and Comparative Examples, the pH of the cured resin was measured by the following method.

1 g of a sample of the cured resin was added to 20 g of ion-exchanged water having a pH of 7.0 at 23° C. The solution including the cured resin was left in a thermostatic chamber kept at 80° C. for 18 hours. After standing for 18 hours, only the solution of the sample which had been returned to room temperature and stirred was transferred to another container, and the pH of the solution was measured with a pH meter. For the pH meter, for example, a pH METER HM-30G of DKK-Toa Corporation was used. At this time, the measured pH of the solution was taken as the pH of the cured resin.

In Example 1, MPTMS was used as a silane coupling agent added to the ultraviolet curing resin of the primary layer. Further, 0.25 wt % of a photoacid generator was added to the ultraviolet curing resin of the primary layer. The pH of the cured resin was 6.6. The Young's modulus of the cured resin after one day from ultraviolet irradiation was 1.87 MPa. The Young's modulus of the cured resin after 30 days from ultraviolet irradiation was 1.96 MPa. The Young's modulus increase amount of the cured resin in the period from 1 day after ultraviolet irradiation to 30 days after ultraviolet irradiation was 0.09 MPa. The Young's modulus increase amount was smaller than or equal to 0.09 MPa, and the evaluation was good (OK).

In Example 2, MPTMS was used as a silane coupling agent added to the ultraviolet curing resin of the primary layer. Further, 0.75 wt % of a photoacid generator was added to the ultraviolet curing resin of the primary layer. The pH of the cured resin was 6.2. The Young's modulus of the cured resin after one day from ultraviolet irradiation was 1.88 MPa. The Young's modulus of the cured resin after 30 days from ultraviolet irradiation was 1.91 MPa. The Young's modulus increase amount of the cured resin in the period from 1 day after ultraviolet irradiation to 30 days after ultraviolet irradiation was 0.03 MPa. The Young's modulus increase amount was smaller than or equal to 0.09 MPa, and the evaluation was good (OK).

In Example 3, MPTMS was used as a silane coupling agent added to the ultraviolet curing resin of the primary layer. Further, 1.25 wt % of a photoacid generator was added to the ultraviolet curing resin of the primary layer. The pH of the cured resin was 5.8. The Young's modulus of the cured resin after one day from ultraviolet irradiation was 1.83 MPa. The Young's modulus of the cured resin after 30 days from ultraviolet irradiation was 1.86 MPa. The Young's modulus increase amount of the cured resin in the period from 1 day after ultraviolet irradiation to 30 days after ultraviolet irradiation was 0.03 MPa. The Young's modulus increase amount was smaller than or equal to 0.09 MPa, and the evaluation was good (OK).

In Example 4, MPTMS was used as a silane coupling agent added to the ultraviolet curing resin of the primary layer. Further, 0.25 wt % of a photoacid generator was added to the ultraviolet curing resin of the primary layer. The pH of the cured resin was 4.8. The Young's modulus of the cured resin after one day from ultraviolet irradiation was 1.42 MPa. The Young's modulus of the cured resin after 30 days from ultraviolet irradiation was 1.44 MPa. The Young's modulus increase amount of the cured resin in the period from 1 day after ultraviolet irradiation to 30 days after ultraviolet irradiation was 0.02 MPa. The Young's modulus increase amount was smaller than or equal to 0.09 MPa, and the evaluation was good (OK).

In Example 5, MPTMS was used as a silane coupling agent added to the ultraviolet curing resin of the primary layer. Further, 0.25 wt % of a photoacid generator was added to the ultraviolet curing resin of the primary layer. The pH of the cured resin was 4.7. The Young's modulus of the cured resin after one day from ultraviolet irradiation was 0.70 MPa. The Young's modulus of the cured resin after 30 days from ultraviolet irradiation was 0.71 MPa. The Young's modulus increase amount of the cured resin in the period from 1 day after ultraviolet irradiation to 30 days after ultraviolet irradiation was 0.01 MPa. The Young's modulus increase amount was smaller than or equal to 0.09 MPa, and the evaluation was good (OK).

In Example 6, MPTMS was used as a silane coupling agent added to the ultraviolet curing resin of the primary layer. Further, 0.25 wt % of a photoacid generator was added to the ultraviolet curing resin of the primary layer. The pH of the cured resin was 4.5. The Young's modulus of the cured resin after one day from ultraviolet irradiation was 0.32 MPa. The Young's modulus of the cured resin after 30 days from ultraviolet irradiation was 0.35 MPa. The Young's modulus increase amount of the cured resin in the period from 1 day after ultraviolet irradiation to 30 days after ultraviolet irradiation was 0.03 MPa. The Young's modulus increase amount was smaller than or equal to 0.09 MPa, and the evaluation was good (OK).

In Example 7, MPTMS was used as a silane coupling agent added to the ultraviolet curing resin of the primary layer. Further, 0.25 wt % of a photoacid generator was added to the ultraviolet curing resin of the primary layer. The pH of the cured resin was 4.7. The Young's modulus of the cured resin after one day from ultraviolet irradiation was 0.20 MPa. The Young's modulus of the cured resin after 30 days from ultraviolet irradiation was 0.22 MPa. The Young's modulus increase amount of the cured resin in the period from 1 day after ultraviolet irradiation to 30 days after ultraviolet irradiation was 0.02 MPa. The Young's modulus increase amount was smaller than or equal to 0.09 MPa, and the evaluation was good (OK).

In Example 8, MPTES was used as a silane coupling agent added to the ultraviolet curing resin of the primary layer. Further, 0.25 wt % of a photoacid generator was added to the ultraviolet curing resin of the primary layer. The pH of the cured resin was 6.5. The Young's modulus of the cured resin after one day from ultraviolet irradiation was 1.92 MPa. The Young's modulus of the cured resin after 30 days from ultraviolet irradiation was 1.96 MPa. The Young's modulus increase amount of the cured resin in the period from 1 day after ultraviolet irradiation to 30 days after ultraviolet irradiation was 0.04 MPa. The Young's modulus increase amount was smaller than or equal to 0.09 MPa, and the evaluation was good (OK).

In Example 9, MPTES was used as a silane coupling agent added to the ultraviolet curing resin of the primary layer. Further, 0.75 wt % of a photoacid generator was added to the ultraviolet curing resin of the primary layer. The pH of the cured resin was 6.3. The Young's modulus of the cured resin after one day from ultraviolet irradiation was 2.01 MPa. The Young's modulus of the cured resin after 30 days from ultraviolet irradiation was 2.02 MPa. The Young's modulus increase amount of the cured resin in the period from 1 day after ultraviolet irradiation to 30 days after ultraviolet irradiation was 0.01 MPa. The Young's modulus increase amount was smaller than or equal to 0.09 MPa, and the evaluation was good (OK).

In Example 10, MPTES was used as a silane coupling agent added to the ultraviolet curing resin of the primary layer. Further, 1.25 wt % of a photoacid generator was added to the ultraviolet curing resin of the primary layer. The pH of the cured resin was 6.1. The Young's modulus of the cured resin after one day from ultraviolet irradiation was 1.84 MPa. The Young's modulus of the cured resin after 30 days from ultraviolet irradiation was 1.89 MPa. The Young's modulus increase amount of the cured resin in the period from 1 day after ultraviolet irradiation to 30 days after ultraviolet irradiation was 0.05 MPa. The Young's modulus increase amount was smaller than or equal to 0.09 MPa, and the evaluation was good (OK).

In Comparative Example 1, MPTMS was used as a silane coupling agent added to the ultraviolet curing resin of the primary layer. Further, a photoacid generator was not added to the ultraviolet curing resin of the primary layer. The pH of the cured resin was 6.8. The Young's modulus of the cured resin after one day from ultraviolet irradiation was 1.69 MPa. The Young's modulus of the cured resin after 30 days from ultraviolet irradiation was 2.10 MPa. The Young's modulus increase amount of the cured resin in the period from 1 day after ultraviolet irradiation to 30 days after ultraviolet irradiation was 0.41 MPa. The Young's modulus increase amount was larger than 0.09 MPa, and the evaluation was poor (NG).

In Comparative Example 2, MPTES was used as a silane coupling agent added to the ultraviolet curing resin of the primary layer. Further, a photoacid generator was not added to the ultraviolet curing resin of the primary layer. The pH of the cured resin was 6.8. The Young's modulus of the cured resin after one day from ultraviolet irradiation was 1.67 MPa. The Young's modulus of the cured resin after 30 days from ultraviolet irradiation was 1.91 MPa. The Young's modulus increase amount of the cured resin in the period from 1 day after ultraviolet irradiation to 30 days after ultraviolet irradiation was 0.24 MPa. The Young's modulus increase amount was larger than 0.09 MPa, and the evaluation was poor (NG).

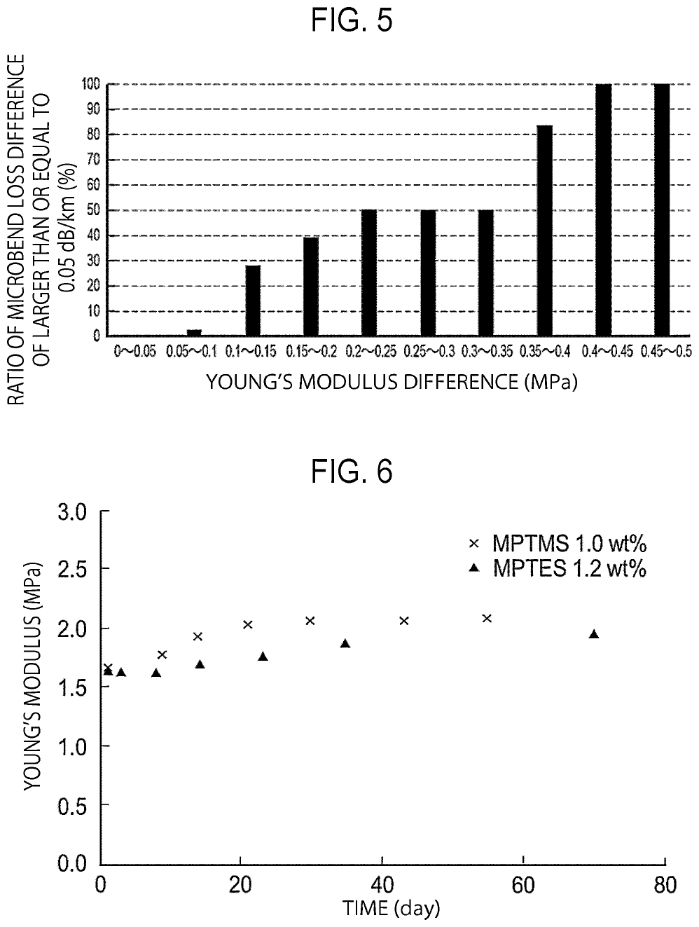

FIG. 5 is a graph illustrating a microbend loss difference with respect to a Young's modulus difference of an optical fiber. In FIG. 5, the Young's modulus difference and the microbend loss difference of the optical fiber are calculated for two optical fibers selected from 19 optical fibers having different Young's moduli of the primary layer. The secondary layer of each optical fiber may be about 1000 MPa. FIG. 5 illustrates a ratio of a microbend loss difference of larger than or equal to 0.05 dB/km for combinations of optical fibers in each classification when optical fiber combinations are classified according to the Young's modulus difference of the primary layer. In FIG. 5, the Young's modulus difference of the primary layer is classified into 0 to 0.05 MPa, 0.05 to 0.10 MPa, 0.10 to 0.15 MPa, 0.15 to 0.20 MPa, 0.20 to 0.25 MPa, 0.25 to 0.30 MPa, 0.30 to 0.35 MPa, 0.35 to 0.40 MPa, 0.40 to 0.45 MPa, and 0.45 to 0.50 MPa. Young's modulus differences of 0 to 0.05 MPa, 0.05 to 0.10 MPa, 0.10 to 0.15 MPa, 0.15 to 0.20 MPa, 0.20 to 0.25 MPa, 0.25 to 0.30 MPa, 0.30 to 0.35 MPa, 0.35 to 0.40 MPa, 0.40 to 0.45 MPa, 0.45 to 0.50 MPa illustrates a Young's modulus difference larger than 0 MPa and smaller than or equal to 0.05 MPa, a Young's modulus difference of larger than 0.05 MPa and smaller than or equal to 0.10 MPa, a Young's modulus difference larger than 0.10 MPa and smaller than or equal to 0.15 MPa, a Young's modulus difference larger than 0.15 MPa and smaller than or equal to 0.20 MPa, a Young's modulus difference larger than 0.20 MPa and smaller than or equal to 0.25 MPa, a Young's modulus difference larger than 0.25 MPa and smaller than or equal to 0.30 MPa, a Young's modulus difference larger than 0.30 MPa and smaller than or equal to 0.35 MPa, a Young's modulus difference larger than 0.35 MPa and smaller than or equal to 0.40 MPa, a Young's modulus difference larger than 0.40 MPa and smaller than or equal to 0.45 MPa and a Young's modulus difference larger than 0.45 MPa and larger than or equal to 0.50 MPa respectively. As illustrated in FIG. 5, when the Young's modulus difference of the primary layer is smaller than or equal to 0.10 MPa, the ratio of the microbend loss difference being larger than or equal to 0.05 dB/km is small, and an increase in the microbend loss accompanying an increase in the Young's modulus of the primary layer is not so observed. On the other hand, when the Young's modulus difference of the primary layer is larger than 0.10 MPa, the ratio of the microbend loss difference of larger than or equal to 0.05 dB/km becomes large, and the increase of the microbend loss accompanying the increase of the Young's modulus of the primary layer rapidly increases. Therefore, in order to effectively suppress microbend loss, the amount of increase in Young's modulus of the primary layer of the optical fiber may be set to smaller than or equal to 0.10 MPa, preferably smaller than or equal to 0.09 MPa.

As illustrated in FIG. 5, when the Young's modulus difference of the primary layer is smaller than or equal to 0.05 MPa, the microbend loss difference of larger than or equal to 0.05 dB/km is not observed. The pH of the primary layer is preferably smaller than or equal to 6.5. By setting the pH of the primary layer to smaller than or equal to 6.5, the amount of increase in Young's modulus of the cured resin in the period from 1 day after ultraviolet irradiation to 30 days after ultraviolet irradiation becomes smaller than or equal to 0.05 MPa, and the microbend loss of the optical fiber accompanying the increase in Young's modulus of the primary layer can be made smaller than 0.05 dB/km.

The Young's modulus of the primary layer of the optical fiber was ISM (In Situ Modulus), and the Young's modulus of the primary layer was measured by the following method.

First, using a commercially available stripper, the primary layer and the secondary layer of the intermediate portion of the optical fiber serving as a sample are peeled off by a length of several millimeters, and then one end of the optical fiber on which the covering layer is formed is fixed on the slide glass with an adhesive, and a load F is applied to the other end of the optical fiber on which the covering layer is formed. In this state, a displacement δ of the primary layer at the boundary between the portion where the covering layer is peeled off and the portion where the covering layer is formed is read by a microscope. Then, by setting the load F to 10, 20, 30, 50, and 70 gf (that is, 98, 196, 294, 490, and 686 mN sequentially), a graph of the displacement δ with respect to the load F is created. Then, the primary elastic modulus is calculated using the slope obtained from the graph and the following equation (2). Since the calculated primary elastic modulus corresponds to the so-called ISM, the primary elastic modulus is appropriately referred to as P-ISM in the following description. When drawing the optical fiber, the drawing speed and the illuminance of the ultraviolet were controlled in order to adjust the P-ISM.

$$P - ISM = ( 3 F / δ ) ⋆ ( 1 / 2 π1 ) ⋆ ln ( DP / DG ) \qquad ( equation ( 2 ) )$$

Here, the unit of P-ISM is [MPa]. In the right side of the equation (2), F/δ is the ratio (inclination) of the change of the load (F) [gf] to the displacement (δ) [μm], 1 is the sample length (for example, 10 mm), and DP/DG is the ratio of the outer diameter (DP) [μm] of the primary layer to the outer diameter (DG) [μm] of the cladding portion of the optical fiber. Therefore, when P-ISM is calculated from the used F, δ, and l by using expression (2), a predetermined unit conversion is required. The outer diameter of the primary layer and the outer diameter of the cladding portion can be measured by observing the cross section of the optical fiber cut by the fiber cutter with a microscope.

Various methods can be considered for measuring the microbend loss. In FIG. 5, the microbend loss was measured by the following method. First, the transmission loss of the optical fiber wound around the bobbin around which the sandpaper was wound was measured, and the transmission loss at this time was defined as the transmission loss of the optical fiber in the state A. Next, the transmission loss of the optical fiber wound on the bobbin on which the sandpaper was not wound was measured, and the transmission loss at this time was defined as the transmission loss of the optical fiber in the state B. The difference between the transmission loss of the optical fiber in the state A and the transmission loss of the optical fiber in the state B was defined as the microbend loss of the optical fiber. Here, the transmission loss of the optical fiber in the state B does not include the transmission loss due to the external force, and is considered to be a transmission loss specific to the optical fiber. The number of the sandpaper is #1000, and the length of the optical fiber is larger than or equal to 400 m. The optical fibers in the state A and the state B are wound around the bobbin so as not to overlap each other. In other words, the optical fibers in the state A and the state B are wound around the bobbin in one layer.

This measurement method is similar to the fixed diameter drum method defined in JIS C6823: 2010. This measurement method is also called a sandpaper method. Further, in this measurement method, since the transmission loss at the wavelength of 1550 nm is measured, the microbend loss according to the present embodiment is also a value at the wavelength of 1550 nm.

Further, the Young's modulus of the secondary layer of the optical fiber was ISM (In Situ Modulus), and the Young's modulus of the secondary layer was measured by the following method.

First, the optical fiber was immersed in liquid nitrogen, and the covering layer was peeled off by a stripper, thereby preparing a sample having only the covering layer in which the bare optical fiber was pulled out from the optical fiber. The end portion of the sample was fixed to an aluminum plate using an adhesive. The aluminum plate portion was chucked using a Tensilon universal tensile tester in an atmosphere at a temperature of 25±5° C. and a relative humidity of 50±10%. Next, the sample was stretched at a marking interval of 25 mm and a tensile speed of 1 mm/min, and the elastic modulus S-ISM (2.5% Secant Modulus) of the secondary layer was calculated by measuring the force at the time of 2.5% stretching.

The pH of the primary layer of the optical fiber may be measured by the following method. A commercially available stripper was used to strip 3 g of the primary layer sample from the optical fiber. 3 g of the sample in the primary layer was added to 30 ml of ion-exchanged water having a pH of 7.0 at 23° C. The solution including the sample in the primary layer was allowed to stand in a thermostatic chamber kept at 80° C. for 18 hours, and then returned to room temperature and stirred. For the pH meter, for example, a pH METER HM-30G of DKK-TOA was used. At this time, the pH of the measured solution was taken as the pH of the primary layer of the optical fiber.

FIG. 6 is a graph illustrating the change over time of the Young's modulus of the ultraviolet curing resin after ultraviolet irradiation, in which the horizontal axis represents the time elapsed from ultraviolet irradiation, and the vertical axis represents the Young's modulus of the ultraviolet curing resin. In FIG. 6, the measurement point represented by “x” indicates the Young's modulus of the sheet-shaped cured resin obtained by adding 1 wt % of MPTMS to the ultraviolet curing resin and irradiating the resin with ultraviolet light. In addition, the measurement point represented by the triangle represents the Young's modulus of a sheet-shaped cured resin obtained by adding 1.2 wt % of MPTES to an ultraviolet curing resin and irradiating the resin with ultraviolet light. The amount of the substance of MPTMS (mol) is substantially equal to the amount of the substance of MPTES (mol). As illustrated in FIG. 6, the Young's modulus of both of the ultraviolet curing resin to which MPTMS is added and the ultraviolet curing resin to which MPTES is added increases with time. It is considered that this is because the silane coupling agents bonded to the ultraviolet curing resin are bonded to each other after ultraviolet irradiation, and a new crosslinking point is generated. Further, as illustrated in FIG. 6, an increase in Young's modulus of the ultraviolet curing resin to which MPTMS was added was observed until 20 days after the ultraviolet irradiation, whereas an increase in Young's modulus of the ultraviolet curing resin to which MPTES was added was observed until 60 days after the ultraviolet irradiation. Here, MPTMS has a methoxy group or a methoxysilyl group as an alkoxy group, and MPTES has an ethoxy group or an ethoxysilyl group as an alkoxy group. In general, a methoxy group is more easily hydrolyzed than an ethoxy group, and a methoxysilyl group is more easily hydrolyzed than an ethoxysilyl group. Therefore, it is considered that the Young's modulus of the ultraviolet curing resin to which MPTES is added is increased over a longer period of time than that of the ultraviolet curing resin to which MPTMS is added. On the other hand, ethoxysilane such as MPTES has higher stability in the state of being added to the resin before curing than methoxysilane such as MPTMS. Therefore, when comparing MPTMS and MPTES, MPTMS is superior in terms of the increase period of Young's modulus after ultraviolet ray irradiation, while MPTES is superior in terms of the stability of the silane coupling agent in the ultraviolet curing resin before curing.

As described above, according to the present embodiment, the curing of the primary layer over time after manufacturing the optical fiber can be suppressed, and the microbend loss can be effectively suppressed.

The present invention is not limited to the embodiments described above, and various modifications are possible. For example, an example in which a part of the configuration of any of the embodiments is added to another embodiment or an example in which a part of the configuration of any of the embodiments is replaced with a part of the configuration of another embodiment is also an embodiment of the present invention. In addition, a known technique or a known technique in the technical field can be appropriately applied to a specific description or a portion not illustrated in the embodiments. In addition, a well-known technique or a publicly known technique in the technical field can be appropriately applied to a portion which is not particularly described or illustrated in the embodiment.

What is claimed is:

1. An optical fiber comprising:
a bare optical fiber;
a primary layer formed of a first ultraviolet curing resin covering the bare optical fiber; and
a secondary layer formed of a second ultraviolet curing resin covering the primary layer,
wherein a Young's modulus of the primary layer is larger than or equal to 0.2 MPa and smaller than or equal to 2.1 MPa, and
wherein the primary layer includes at least one of an alkoxysilane-derived chemical structure or a halosilane-derived chemical structure.

2. The optical fiber according to claim 1, wherein the primary layer is acidic.

3. The optical fiber according to claim 1, wherein a Young's modulus increase amount of the primary layer before and after 29 days of storage in an atmosphere having a temperature of 25±5° C. and a relative humidity of 50±10% is smaller than or equal to 0.09 MPa.

4. The optical fiber according to claim 1, wherein a pH of the primary layer is smaller than or equal to 6.6.

5. The optical fiber according to claim 1, wherein the first ultraviolet curing resin includes a photoacid generator.

6. The optical fiber according to claim 5, wherein an amount of the photoacid generator added to the first ultraviolet curing resin is larger than or equal to 0.25 wt %.

7. The optical fiber according to claim 1, wherein the first ultraviolet curing resin is crosslinked through at least one of an alkoxysilane-derived chemical structure or a halosilane-derived chemical structure.

8. The optical fiber according to claim 1, wherein the first ultraviolet curing resin includes a mercapto group and at least one of an alkoxysilane or a halosilane.

9. The optical fiber according to claim 4,
wherein a pH of the primary layer is smaller than or equal to 6.5, and
wherein a Young's modulus increase amount of the primary layer before and after 29 days of storage in an atmosphere having a temperature of 25±5° C. and a relative humidity of 50±10% is smaller than or equal to 0.05 MPa.

10. A method for manufacturing an optical fiber comprising:
a step of drawing a bare optical fiber from an optical fiber preform;
a step of forming a primary layer by applying a first ultraviolet curing resin around the bare optical fiber; and
a step of forming a secondary layer by applying a second ultraviolet curing resin around the primary layer,
wherein a Young's modulus of the primary layer is larger than or equal to 0.2 MPa and smaller than or equal to 2.1 MPa, and
wherein the primary layer includes at least one of an alkoxysilane-derived chemical structure or a halosilane-derived chemical structure.

11. The method for manufacturing the optical fiber according to claim 10, wherein the primary layer is acidic.

12. The method for manufacturing the optical fiber according to claim 10, wherein a Young's modulus increase amount of the primary layer before and after 29 days of storage in an atmosphere having a temperature of 25±5° C. and a relative humidity of 50±10% is smaller than or equal to 0.09 MPa.

13. The method for manufacturing the optical fiber according to claim 10, wherein a pH of the primary layer is smaller than or equal to 6.6.

14. The method for manufacturing the optical fiber according to claim 10, wherein the first ultraviolet curing resin includes a photoacid generator.

15. The method for manufacturing the optical fiber according to claim 14, wherein an amount of the photoacid generator added to the first ultraviolet curing resin is larger than or equal to 0.25 wt %.

16. The method for manufacturing the optical fiber according to claim 10, wherein the first ultraviolet curing resin is crosslinked through at least one of an alkoxysilane-derived chemical structure or a halosilane-derived chemical structure.

17. The method for manufacturing the optical fiber according to claim 10, wherein the first ultraviolet curing resin includes a mercapto group and at least one of an alkoxysilane or a halosilane.

18. The method for manufacturing the optical fiber according to claim 10,
wherein a pH of the primary layer is smaller than or equal to 6.5, and
wherein a Young's modulus increase amount of the primary layer before and after 29 days of storage in an atmosphere having a temperature of 25±5° C. and a relative humidity of 50±10% is smaller than or equal to 0.05 MPa.
